(19) United States
(12) Patent Application Publication
(10) Pub. No.: US 2012/0062879 A1
(43) Pub. Date: Mar. 15, 2012

(54) Measuring Instrument for Determining the Tissue Alcohol Concentration

(75) Inventors: Hartmut Spennemann, Aschaffenburg (DE); Ulrich Kallmann, Tuebingen (DE)

(73) Assignee: Robert Bosch GmbH, Stuttgart (DE)

(21) Appl. No.: 13/233,933

(22) Filed: Sep. 15, 2011

(30) Foreign Application Priority Data
Sep. 15, 2010 (DE) 10 2010 040 783.6

(51) Int. Cl. G01J 3/00

(52) U.S. Cl. 356/300

(57) ABSTRACT

A measuring instrument for determining the concentration of components in the body tissue by reflection spectroscopy is disclosed. In order, inter alia, to increase the functional reliability in the case of vibrations, the measuring instrument includes a diode laser with at least one laser diode and a waveguide structure, which has an external resonator, with a wavelength selective element, for each laser diode. In the process, the radiation generated by a laser diode is coupleable into the waveguide structure and the corresponding resonator and once again decoupleable from the resonator and the waveguide structure. Moreover, a corresponding method and a motor vehicle equipped therewith are disclosed.

This application claims priority under 35 U.S.C. §119 to German patent application no. DE 10 2010 040 783.6, filed Sep. 15, 2010 in Germany, the disclosure of which is incorporated herein by reference in its entirety.

### BACKGROUND

The present disclosure relates to a measuring instrument for determining the concentration of components in the body tissue, more particularly for determining the alcohol concentration in the body tissue, and to a corresponding method and a motor vehicle equipped therewith.

There are instruments that can determine the tissue alcohol concentration in the body with the aid of optical spectroscopy in the near-infrared spectral range. In the process, a body part, for example a hand or forearm, is placed on the measurement site of the instrument and the reflection spectrum of the tissue is measured in a spectral range between approximately 2100 nm and 2400 nm. The alcohol concentration in the tissue is calculated from this spectrum.

Currently, measuring instruments are used for this purpose, which have a thermal light source and an interferometer in a free-beam arrangement. However, these measuring instruments require vibration-free and thermally stable surroundings and also require space approximately corresponding to the size of a shoebox. Moreover, the spectral power density is limited in the case of thermal light sources, and this puts a lower limit on the measurement time required for obtaining a sufficient signal-to-noise ratio (SNR).

### SUMMARY

The subject matter of the present disclosure relates to measuring instrument for determining the concentration of components in the body tissue, in particular by reflection spectroscopy, for example for determining the alcohol concentration in the body tissue, which measuring instrument comprises a diode laser, with at least one laser diode, and a waveguide structure. Here the waveguide structure has an external resonator, with a wavelength selective element, for each laser diode. Here the waveguide structure is embodied and arranged such that the radiation generated by the laser diodes of the diode laser is respectively coupleable into the resonator associated with the respective laser diode and is decoupleable again after passing through the resonator.

The use of diode lasers in place of thermal light sources advantageously allows the direct modulation of the radiation intensity and hence a simple option for a lock-in detection for improving the signal-to-noise ratio and for a higher spectral power density. As a result, the measurement time can in turn be reduced in the case of an unchanging signal-to-noise ratio or the signal-to-noise ratio can in turn be improved in the case of an unchanging measurement time. Routing the radiation in the waveguide structure can, moreover, advantageously significantly reduce the required installation space compared to known free-beam solutions. Moreover, the measuring instrument becomes significantly more robust against vibrations as a result of the waveguide structure. Moreover, the measuring instrument according to the disclosure can have a smaller and more compact design than known free-beam solutions as a result of using the diode laser and the waveguide structure, and it can be encapsulated or housed in an improved fashion. Moreover, the selected design can make the measuring instrument more robust against thermal drift because, firstly, laser diodes generate less waste heat than thermal light sources and, secondly, active temperature stabilization of the entire measuring instrument is possible, e.g. using a Peltier cooler, as a result of the compactness and encapsulation. In conclusion, the instrument according to the disclosure can be smaller, more robust and faster than conventional instruments for measuring tissue alcohol concentrations and can therefore for example be suited to use in a motor vehicle.

Within the scope of an embodiment of the measuring instrument according to the disclosure, the measuring instrument furthermore comprises a first and second optical waveguide, measuring optics and a first photodiode. Here, the radiation from the waveguide structure is decoupleable into the first optical waveguide, wherein the radiation is transmittable onto the body tissue to be examined through the first optical waveguide and the measuring optics. In the process, the radiation reflected by the body tissue is transmittable onto the first photodiode through the measuring optics and the second optical waveguide, and measureable by the first photodiode. This is advantageous in that, as a result of the optical waveguides, the body tissue measurement point is independent of the point of the radiation generation and measurement, or variable with respect thereto.

Within the scope of a further embodiment of the measuring instrument according to the disclosure, the diode laser and the waveguide structure are embodied and arranged such that the radiation generated by the diode laser is directly coupleable into the waveguide structure, i.e. without interjacent additional components. Directly coupling the diode laser to the waveguide structure advantageously allows a further reduction in the required installation space, particularly with respect to known free-beam solutions.

Within the scope of a further embodiment of the measuring instrument according to the disclosure, the wavelength selective element is designed to tune the radiation wavelength, preferably over the entire gain bandwidth. This can increase the measurement accuracy and increase the number of the components that are determinable using the measuring instrument.

Within the scope of a further embodiment of the measuring instrument according to the disclosure, the wavelength selective element comprises or is a micro- or nano-structured component, more particularly a so-called micro-electro-mechanical system (MEMS) and/or a micro-opto-mechanical system (MOEMS). Within the scope of the present disclosure, a “micro- or nano-structured component” can in particular be understood to mean a component with internal-structure dimensions in the range between ≧1 nm and ≦200 μm. Here, “internal-structure dimensions” can in particular be understood to mean dimensions of structures within the component, such as struts, webs or printed circuit boards. The use of micro- or nano-structured components for wavelength selection can advantageously further reduce the required installation space, particularly with respect to known free-beam solutions. Moreover, the use of wavelength selective elements on the basis of micro- or nano-structured components makes the measuring instrument significantly more robust against vibrations and allows a smaller design thereof compared to known free-beam solutions.

The wavelength selective element can be positioned both in the resonator and at the end of the resonator.

Within the scope of an embodiment of the measuring instrument according to the disclosure, the wavelength selective element comprises a diffraction grating or a Fabry-Pérot interferometer or an etalon, in particular one in which the wavelength selection or the path of the optical radiation is adjustable by at least one micro- or nano-structured component controlled in a capacitive, inductive and/or piezoelectric fashion. By way of example, the wave selective element can comprise a diffraction grating, the alignment of which is adjustable by at least one micro- or nano-structured component controlled in a capacitive, inductive and/or piezoelectric fashion. Or the wave selective element can comprise a Fabry-Pérot interferometer, in which the spacing between the reflective surfaces is adjustable by at least one micro- or nano-structured component controlled in a capacitive, inductive and/or piezoelectric fashion. Or the wave selective element can comprise an etalon, in which the optical path length between the reflective surfaces or the alignment thereof is adjustable by at least one micro- or nano-structured component controlled in a capacitive, inductive and/or piezoelectric fashion. A diffraction grating as wavelength selective element can in particular be positioned at the resonator end, particularly in a Littmann configuration. A Fabry-Pérot interferometer or an etalon as a wavelength selective element can in particular be positioned in the resonator.

The external resonator preferably has a Littmann or Littrow configuration. A Littrow configuration can advantageously be used to tune a laser diode over 150 nm.

In particular, the laser diodes can have a coated end facet and be positioned in front of the waveguide structure such that the generated radiation is directly coupleable into the waveguide structure.

In particular, the laser diodes can generate laser radiation in a range between ≧1800 nm and ≦2500 nm. This wavelength range is particularly suitable for determining the alcohol concentration in the body tissue.

By way of example, the laser diodes can be gallium-antimony-based laser diodes, for example a (AlGaIn)/(AsSb)-based laser diode, for example GaInAsSb/AlGaAsSb laser diodes.

Within the scope of an embodiment of the measuring instrument according to the disclosure, the diode laser comprises at least two, more particularly three, different laser diodes. This advantageously allows laser radiation with different wavelengths to be generated simultaneously or with a time offset. The radiation of two or more different laser diodes can be combined by the waveguide structure depending on the desired spectral bandwidth and required spectral power density. By way of example, a combination of the radiation from the laser diodes can, overall, cover a wavelength range between at least ≧2100 nm and ≦2400 nm. In particular, the wavelength of the radiation can in the process be tunable in the spectral range between at least ≧2100 nm and ≦2400 nm.

Within the scope of an embodiment of the measuring instrument according to the disclosure, the gain bandwidths of the individual laser diodes are selected such that a combination of all laser diodes covers a wavelength range between ≧2100 nm and ≦2400 nm. This wavelength range is particularly advantageous for determining the alcohol concentration in the body tissue.

The waveguide structure is preferably a silicon-based structure. Such structures are advantageously relatively insensitive to vibrations and temperature variations.

Within the scope of an embodiment of the measuring instrument according to the disclosure, the waveguide structure is embodied such that the radiation of the laser diodes is firstly, in each case separately from one another, coupleable into the resonator associated with the respective laser diode and the radiation decoupled from the resonators, in particular from all laser diodes, is focusable.

Within the scope of an embodiment of the measuring instrument according to the disclosure, the waveguide structure is embodied such that the radiation is splittable, downstream of the resonator and optionally after focusing the radiation or beam paths of the individual laser diodes, wherein part of the radiation is decoupleable into the first optical waveguide and another part of the radiation is transmittable to a second photodiode and is measurable by the second photodiode. Comparing the measured reflected radiation to such a reference radiation can advantageously increase the measuring accuracy with respect to measuring instruments that only use stored emission data of the laser diodes.

A first and/or second photodiode is preferably a cooled photodiode, more particularly a Peltier-element-cooled photodiode. More particularly, the first and/or second photodiode can be is an InGaAs photodiode.

The first and second optical waveguide can comprise or consist of optical fibers, e.g. glass fibers and/or polymer optical fibers.

Further subject matter of the present disclosure relates to a method for determining the concentration of components in the body tissue by reflection spectroscopy, more particularly for determining the alcohol concentration in the body tissue, more particularly with a measuring instrument according to the disclosure. The method comprises the method steps of:
generating radiation by at least one laser diode, wherein the radiation wavelength is tuned in a step-wise or continuous fashion, more particularly in a range between ≧2100 nm and ≦2400 nm, for example by a resonator;
radiating the radiation into the body tissue to be examined;
measuring the intensity of the radiation reflected by the body tissue as a function of the radiation wavelength; and
determining the concentration of at least one component of the body tissue from the obtained data.

Here, the radiation can be generated simultaneously or in succession by two or more different laser diodes. Accordingly, it is possible to tune a plurality of radiation wavelengths simultaneously or in succession, in a continuous or step-wise fashion.

In respect of further features and advantages, reference is hereby explicitly made to the explanations in conjunction with the measuring instrument according to the disclosure.

Further subject matter of the present disclosure relates to a motor vehicle, comprising a measuring instrument according to the disclosure or a measuring instrument carrying out a method according to the disclosure.

### BRIEF DESCRIPTION OF THE DRAWINGS

Further advantages and advantageous embodiments of the subject matter according to the disclosure are illustrated by the drawing and explained in the following description. It should be noted here that the drawing only has a descriptive character and is not envisaged to restrict the disclosure in any form. In detail:

FIG. 1 shows a schematic cross section through an embodiment of a measuring instrument according to the disclosure.

### DETAILED DESCRIPTION

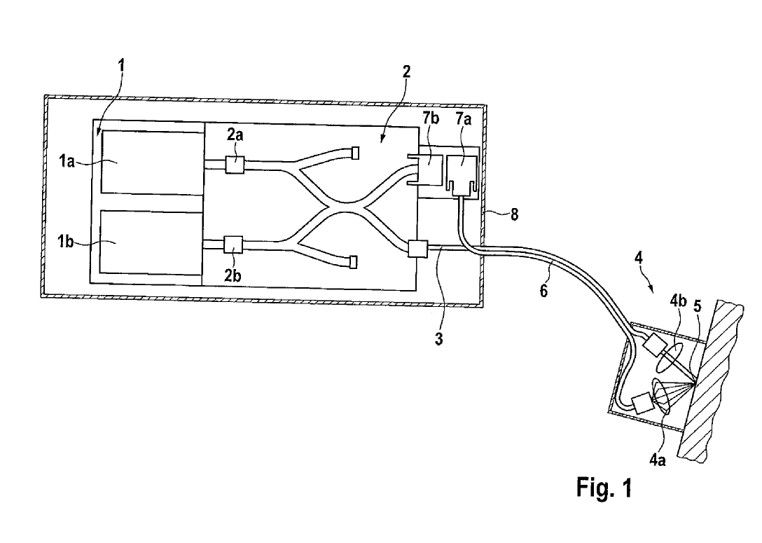

FIG. 1 shows an embodiment of a measuring instrument according to the disclosure for determining the concentration of components in the body tissue by reflection spectroscopy. FIG. 1 shows that the measuring instrument comprises a diode laser 1, with two different laser diodes 1a, 1b, and a waveguide structure 2. FIG. 1 illustrates that the waveguide structure 2 has an external resonator 2a, 2b, with a wavelength selective element (not illustrated), for each laser diode 1a, 1b. Furthermore, FIG. 1 shows that the measuring instrument comprises a first 3 and second 6 optical waveguide, measuring optics 4 and a first photodiode 7a. Here, the diode laser 1, the waveguide structure 2 and the photodiodes can be integrated in a housing that is connected to the measuring optics 4 via the first 3 and second 6 optical waveguide.

FIG. 1 illustrates that the radiation generated in the laser diodes 1a, 1b is coupleable into the waveguide structure 2 and the resonator 2a, 2b associated with the respective laser diode 1a, 1b, and is decoupleable again from the resonator 2a, 2b and the waveguide structure 2. In particular, FIG. 1 shows that the radiation generated by the two laser diodes 1a, 1b is coupled directly, in each case separately from one another, into the waveguide structure 2. In the waveguide structure 2, the radiation is, still separate from one another, coupled into the resonator 2a, 2b associated with the respective laser diode 1a, 1b and, still separate from one another, decoupled from the resonator 2a, 2b again. FIG. 1 shows that the waveguide structure 2 is also embodied such that the radiation or the radiation paths from the two laser diodes 1a, 1b is focused after decoupling from the individual resonators 2a, 2b.

FIG. 1 illustrates that the waveguide structure 2 is also embodied such that, after the resonators 2a, 2b and after the focusing with the radiation or the radiation paths, the radiation is once again split such that the main part of the radiation is decoupleable into a first optical waveguide 3, via which the radiation is transmittable onto the body tissue to be examined and finally onto the first photodiode, with another part of the radiation being transmittable onto a second photodiode 7b.

FIG. 1 shows that, in the process, there is coupling into the measuring optics 4 through the first optical waveguide 3, via which optics the radiation is radiated into the body tissue to be examined or the measurement site in the tissue 5 and the radiation reflected from the tissue is coupled into the second optical waveguide 6. By way of example, this can be brought about via a lens system 4a, 4b and/or other optical elements. This radiation can then be transmitted to the first photodiode 7a via the second optical waveguide 6. This is how the first photodiode 7a measures the reflected radiation, wherein the second photodiode 7b measures the original radiation not reflected on the body tissue and can be used to calibrate the measurement result from the first photodiode 7a. During a measurement, the wavelength in the spectral range, for example between 2100 nm and 2400 nm, can be tuned in a step-wise or continuous fashion using the different laser diodes 1a, 1b and the external resonators thereof, more particularly the wavelength selective elements of the resonators, and the intensity reflected in the tissue can be detected as a function of the wavelength. This is how the reflection spectrum of the tissue is determined, from which the alcohol concentration or else other components in the tissue can then be determined.

What is claimed is:

1. A measuring instrument for determining the concentration of components in the body tissue by reflection spectroscopy, more particularly for determining the alcohol concentration in the body tissue, comprising:
a diode laser with at least one laser diode; and
a waveguide structure, which has an external resonator, with a wavelength selective element, for each laser diode,
wherein the waveguide structure is embodied and arranged such that the radiation generated by the laser diodes of the diode laser is respectively coupleable into the resonator associated with the respective laser diode and is decoupleable again after passing through the resonator.

2. The measuring instrument as claimed in claim 1, wherein the measuring instrument further comprises:
a first and second optical waveguide;
measuring optics; and
a first photodiode,
wherein the radiation from the waveguide structure is decoupleable into the first optical waveguide,
wherein the radiation is transmittable onto the body tissue to be examined through the first optical waveguide and the measuring optics,
wherein the radiation reflected by the body tissue is transmittable onto the first photodiode through the measuring optics and the second optical waveguide, and measureable by the first photodiode.

3. The measuring instrument as claimed in claim 1, wherein the diode laser and the waveguide structure are embodied and arranged such that the radiation generated by the diode laser is directly coupleable into the waveguide structure.

4. The measuring instrument as claimed in claim 1, wherein the wavelength selective element is designed to tune the radiation wavelength.

5. The measuring instrument as claimed in claim 1, wherein the wavelength selective element comprises a micro- or nano-structured component.

6. The measuring instrument as claimed in claim 1, wherein the wavelength selective element comprises a diffraction grating or a Fabry-Pérot interferometer or an etalon, in particular one in which the wavelength selection is adjustable by at least one micro- or nano-structured component controlled in a capacitive, inductive and/or piezoelectric fashion.

7. The measuring instrument as claimed in claim 1, wherein the diode laser comprises at least two different laser diodes.

8. The measuring instrument as claimed in claim 1, wherein the gain bandwidths of the individual laser diodes are selected such that a combination of all laser diodes covers a wavelength range between ≧2100 nm and ≦2400 nm.

9. The measuring instrument as claimed in claim 1, wherein the waveguide structure is embodied such that the radiation of the laser diodes is firstly, in each case separately from one another, coupleable into the resonator associated with the respective laser diode and the radiation decoupled from the resonators is focusable.

10. The measuring instrument as claimed in claim 1, wherein the waveguide structure is embodied such that the radiation is splittable, downstream of the resonator and optionally after focusing the radiation of the individual laser diodes, wherein part of the radiation is decoupleable into the first optical waveguide and another part of the radiation is transmittable to a second photodiode and is measurable by the second photodiode.

11. A method for determining the concentration of components in the body tissue by reflection spectroscopy, more particularly for determining the alcohol concentration in the body tissue, comprising:
generating radiation by at least one laser diode, wherein the radiation wavelength is tuned in a step-wise or continuous fashion, more particularly in a range between ≧2100 nm and ≦2400 nm, for example by a resonator;
radiating the radiation into the body tissue to be examined;
measuring the intensity of the radiation reflected by the body tissue as a function of the radiation wavelength; and
determining the concentration of at least one component of the body tissue from the obtained data.

12. A motor vehicle having a measuring instrument for determining the concentration of components in the body tissue by reflection spectroscopy, more particularly for determining the alcohol concentration in the body tissue, the measuring element comprising:
a diode laser with at least one laser diode; and
a waveguide structure, which has an external resonator, with a wavelength selective element, for each laser diode,
wherein the waveguide structure is embodied and arranged such that the radiation generated by the laser diodes of the diode laser is respectively coupleable into the resonator associated with the respective laser diode and is decoupleable again after passing through the resonator.

13. The measuring instrument as claimed in claim 5, wherein the micro- or nano-structured component is an MEMS and/or an MOEMS.
